(19) United States
(12) Patent Application Publication
(10) Pub. No.: US 2012/0317501 A1
(43) Pub. Date: Dec. 13, 2012

(54) Communication & Collaboration Method for Multiple Simultaneous Users

(76) Inventor: Anthony Constantine Milou, Sydney (AU)

(21) Appl. No.: 13/492,858

(22) Filed: Jun. 9, 2012

Related U.S. Application Data
(60) Provisional application No. 61/495,358, filed on Jun. 9, 2011.

(51) Int. Cl. G06F 3/01; G06F 15/16

(52) U.S. Cl. 715/753

(57) ABSTRACT

The invention is a computerized process for online communication and collaboration between multiple remotely located users. All input by users is handled within a Spatial Environment containing multiple real-time applications. All users are able to visualize and identify the exact nature of each other's input actions (e.g. tapping, clicking, dragging or scrolling actions) so they are able to quickly judge the nature and potential for their own input in relation to all the observable activity. Every act of communication, adjustments to interface controls, settings and any other data input made by any single user can be interfaced with or observable by all of the users who are present. The nature of the communication and collaboration therefore offered by the invention provides a degree of immediacy, scale and adaptability which is not achievable with currently available methods.

### RELATED APPLICATIONS

This application claims the benefit of U.S. Provisional Patent Application Ser. No. 61/495,358 titled Communication & Collaboration Method for Multiple Simultaneous Users, filed on Jun. 9, 2011 by the inventor of the present application, the contents of which are incorporated herein by reference.

### BACKGROUND OF THE INVENTION

1. Field of the Invention

The present invention relates generally to a communication & collaboration method for multiple simultaneous users.

2. Background

Given the increase in efficiency for transmitting large volumes of data over the internet, an opportunity exists to provide services which allow multiple people to communicate and collaborate together with a high degree of immediacy, irrespective of the physical distances that may exist between them. A variety of distinct tasks can be performed with such collaborative online services, from editing a video to interpreting medical results or writing an essay; all of which are tasks that could benefit from the diverse input of multiple individuals, rather than being carried out individually and in social isolation. Given the growing complexity of tasks performed within organizations, and the growing time constraints to complete such tasks, real-time collaboration is both helpful and desirable. Indeed, given the complexity of many problems which we collectively face in the world, such as those related to the environment, effective governance, urban planning, health and education; a more effective means of collaboratively facing those challenges is required.

Currently there are a number of solutions that allegedly provide a variety of methods and systems to facilitate communication and collaboration online. Some of these methods and systems attempt to take advantage of real-time technologies so that users can receive information as soon as it is published by its authors. The known methods focus on such things as status updates, collaborative writing or real time drawing applications where multiple remote users can draw at the same time within the same online canvas.

Generally speaking, these known methods and systems typically do not allow for or envision users collaborating in a single shared space where multiple applications are available, and the precise activity of all users is discernable as it happens in real-time, no matter how many applications or users are present within that single space. With some of the known methods, multiple applications can be present within a given space in the form of widget applications. With the presence of multiple widget applications in a given space, it is therefore possible for many applications to reside within the same space and to observe the activity of all users simultaneously. An example of such an application is the now discontinued Google Wave which specifically allowed users to collaborate within a multitude of widget applications in real-time. However widgets have their disadvantage in that the screen area that is available must be shared by all applications present there. Consequently widget applications are relatively small in size when compared to standard sized applications (e.g. word processors, spreadsheets or media editing software) which take up the full or majority area of a user's screen and therefore widget type applications have limited utility in comparison.

Still other methods and systems allow users to see multiple fully featured applications in overview, and then allow users to zoom in on a single application in order to interact with it. An example would be the user interface used by online gaming platforms such as Onlive, where all games currently being played are shown in real-time as an overview, allowing a user to then click on a single selection, at which point the interface will zoom into that game application and allow interaction with it. With such current methods however users are not able to distinctly discern all the precise actions of all users in attendance, and across all the applications present. Most critically, users are unable to move freely between the applications as each is a distinct and separate system, requiring log-in/log-out, setup and each application gives a user a unique identity which is non-transferable. Consequently the ability to transfer data between applications or for a user to directly move between applications is also non-existent. In such methods therefore the ability for users to coordinate their activities across all the applications present is not feasible. Coordination of user activity across multiple applications, available within a single spatial environment, is desirable as it facilitates the completion of complex tasks which cannot be satisfied by the features present within any single application or the talents of a single individual (e.g. a company developing a new product where Computer Aided Design drawing, writing and budget calculation activities are required or collaboration between groups of students to complete a class project where writing, drawing and editing of video is required).

Similarly, existing solutions fail to meet the needs of the industry because they do not enable clear identification of what in fact are the precise actions of all users across multiple applications present. Such precise actions would include but not limited to, visualization and animation of each users movements across the screen, as well as visualization and animation of clicking, scrolling, typing and dragging forms of user input. The ability to see the exact nature of every users input and movements across all applications present would be advantageous because it would generally facilitate improved understanding into what, how and where activity is taking place; effectively allowing any attending user to better judge the nature of their own input in relation to the observable activity; they can judge in what way, how and where to join in more precisely than with current methods.

All the above described solutions fail to meet the needs of the industry because they do not allow at once for both full sized and full featured multiple applications to be operable in the one spatial environment by multiple users, while also allowing for all the actions taking place by all users to be discernable; all of which are desirable for effective communication and collaboration to tackle group related activity.

### SUMMARY OF THE INVENTION

In view of the foregoing, it is therefore an object of various embodiments of the invention to, among other things, provide a mechanism that allows users to engage in communication and collaboration through interaction across multiple full sized and full featured real-time applications, all of whom and which respectively are present simultaneously within a single Spatial Environment (SPE) using a Zoom User Interface (ZUI) for navigation.

The present invention advantageously allows all participating users to see each other's inputs and movements more clearly across all applications present as each of these actions is visualized and animated in real-time for all users to observe. Each user is identified by an avatar representation which is displayed within the user interface. As the avatars within the real-time zoom system visualize and animate the movements and inputs of each users actions in real-time, a clear discerning is possible of what, who and where these actions are taking place. Further, the invention provides users with the ability to choose from a list of real-time applications which may be selected to populate the real-time zoom system. In so doing, many real-time applications may ultimately be selected and thus all occupy the same screen area of the user interface (one above the other and/or side to side of each other). In this way the applications provide within the real-time zoom system localized centers of activity within which users can collaborate to complete certain types of task; where the specific feature set of each application determines the type and intensity of tasks at each of these centers of activity (e.g. collaborative text input within a word processor, multi user sketching activity within a drawing application or collaborative editing of a film within a video editor). There are no interoperability restrictions (e.g. restrictions such as each application having its own user identity which is non-transferable, log-in/log-out or setup requirements), as each application occupies the one and the same Spatial Environment and allows for direct movement of users and data between the applications when and as required. Still further, the invention provides the required zoom capabilities, native to the user interface (i.e. a zoom user interface or ZUI), and it is this capability that allows multiple large sized and fully featured applications to occupy and share the same limited area available within the real-time zoom system. Users see in real-time a zoomed out view of all applications and user activity, and then in order to enable practical participation, click or touch on a selected application to zoom in and interact with other users and/or data in close up view. Through a click or touch action a user is then able to zoom out for an overview of all present activity again. The zoom capabilities therefore allow users to move closer to or farther from specific applications for uninterrupted engagement. In summation, all user activity is discernable in overview, with zooming in and out allowing for practical and uninterrupted engagement with specific applications.

Exemplary embodiments of the present invention include a computer implemented method or process where end user input is made within a multitude of applications available within a user interface, with all the distinct inputs and movements by the end user visualized and animated so that it is displayed in avatar form, in order for all other remote users being present within the interface to discern. Each users avatar is not by default visible to themselves but to all other users which are present within the user interface. Each users name can also be displayed next to their avatar.

This computer implemented process can be made up of the following executable steps: The end user observes the activity of every other user's avatars in terms of their movement and animation, who happen to be present across all and any applications available within a Spatial Environment. All user activity is processed and displayed in real-time within the Spatial Environment and navigated by the means of a Zoom User Interface. The total observable avatar activity and applications informs the end user as to which specific activity and application from those present they will want to engage in, at which point the end user selects a single application from the applications available. Upon selecting a single application the user interface displays a zoomed in view of the application. The user then may proceed to make movements and inputs within the selected application and in relation to the inputs and movements of all other users who are identifiable by their avatars within that application. In order to discern the exact actions of each of the avatars present, the user observes the avatar visualization and animation of their clicking, scrolling, typing and dragging forms of user input provided by the real-time zoom system. The user then may further proceed to zoom out of the selected application and once again all applications are in view from which to make an additional selection, based on all the real-time observable activity.

In other embodiments the present invention may also have one or more of the following optional executable steps:
(1) Saving all applications and their associated inputs within a Spatial Environment so that it may be returned to at a later date. Any addition, amendment or movement of user input by a user, results in the new associated value logged automatically and in real-time as they happen, allowing users to return and further work within the Spatial Environment at a later date and time.
(2) The assigning of a specific web address in the form of a unique URL for each and all saved Spatial Environments, and in so doing enable users to inform others of the URL and allow them to also participate via a web browser. Visiting a unique URL will cause all of its logged inputs to date to be loaded and displayed to the user. All changes by users are logged incrementally as they happen, thus multiple users from multiple remote locations may make changes within a single Spatial Environment simultaneously.
3) Allow users to remove existing applications or add additional applications to a Spatial Environment. The addition of an application will result in that application being located above, below or to the side of existing applications within a given SPE. Additional applications are to be selected from a list accessible form within the real-time zoom system.
4) Allow for the division and subsequent subdivision of the available area of a Spatial Environment so that additional applications can occupy the same limited space available. Applications will occupy the specific area defined by the divided and subdivided space. Through the navigation afforded by the Zoom User Interface, a user can zoom in or out of the applications within the divisions and subdivisions. Each subsequent subdivision of a division requires a greater level of zooming in by a user so that the applications there are to appear full sized to the user. Divisions and subdivisions created can for example represent the organizational structure of institutions or groups of users with a common interest (e.g. create divisions and/or subdivisions to closely match the organizational layout of a school where students and teachers are carried out). Each division and subdivision can be labeled through alpha numeric means and allow users to click or touch either the label or a button close by to select and zoom in on a specific division or subdivision.
5) Provide real-time video chat and/or messaging features within each available Spatial Environment in order for users to communicate directly with each other in relation to the observable activity within the Spatial Environment. The video chat room and/or messaging services are unique to each and every spatial environment in the system.
6) Provide the option for any user to disconnect from other users within a Spatial Environment, (and re-connect when they wish) and in so doing allow them to interact with applications in isolation. Data input by a disconnected user or by the other users within applications will still be updated and the data will still be observable by all (e.g. uploading of photos, status updates or communicating within a video chat room). The act of disconnection by a given user will mean that the Avatars of other users are no longer visible to the disconnected user, and that any adjustments of user interface controls within applications (e.g. the rotation of a volume control knob, or the scrolling of content within an application by other users) will not be observable. Consequently any adjustments of user interface controls by the disconnected user will not be observable to the other users. Essentially disconnection severs for any given user the real-time and collaborative engagement. The availability of buttons within the SPE (e.g. labeled “Work Live” and “Work Solo” where “Work Live” is the default setting).
7) Allow for any user to change their avatar representation so that it can be customized. The customization can involve changing the form, color or any alpha numeric labeling which accompanies the avatar. In addition users may also have the option of expressing happiness, sadness, excitement and other expressions via preset visualizations that may animate their avatar for a set period of time with the purpose of making other users aware of those expressions.
8) Allow users to click on or touch the avatars of other users; “a bump to chat” feature. For example a user can move their avatar over the avatar of another user within a SPE and click on them in order to make the other user aware that they want to specifically communicate right now with them.
9) Allow users the option to apply filters so that only a specific selection of the users present are visible within a SPE at any given time. The option is especially advantageous when there are many users present within a given SPE and a user would like to identify a specific type of user to engage with (e.g. make visible only a user with a specific name they have searched for or make visible only the top 10 most prolific users). Users can also filter based on popularity, activity input etc.
10) An application programming interface (API) to allow third party application developers to both create and allow users to access these third party applications.
11) Allow users to select who can participate in a SPE. When a SPE is first created, it is then possible to be defined by an end user as either an Open Access Session, a Selective Access Session or a Personal Session. In an Open Access Session any registered and or unregistered user can access a session and add input. In a Selective Session any registered and/or unregistered user can request or can be invited to have input to the session. A request or invite can be initially granted by the end user who first has a session saved for them. Of those invited or who have had their input request granted, a select number can be therein authorized (authorized by the end user who first saved a session) to grant a request or instigate an invite. Access to a selective session is either open to all or restricted to those invited or that have a granted request. In a Personal Session any registered and or unregistered user who first saves a session may specify that only they may have input to a session. Access to a personal session is either specified by the user who first saves a session, as open to all users or restricted to the user who first saves a session.
12) Providing users with social status rankings, represented in text or image form. The social status rankings of a user may be calculated relative to all other users of a particular saved session. The social status rankings may also be calculated relative to all the users of the application. The social status rankings may be categorized and calculated based on a popularity of input added. The system may determine the popularity of input by tracking clicks with SPE applications provided by a particular user. The user may be progressively given a higher social status ranking representing that number of clicks. The social status rankings may be also be categorized and calculated based on the volume or type of input provided by a particular user. Users are progressively given a higher social status ranking representing the total number of input they have made within the application as well as recording what that input was. The social status rankings may be also be categorized and calculated based on the number of followers a user has attracted. Users are progressively given a higher social status ranking representing the total number of other users who are keeping a tab on their sessions which they have saved, been invited to or have been granted a request to join.
13) Users are able to transfer data to other users within a SPE by moving to click on or touch the other user, as illustrated in example 2, FIG. 6B.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a block diagram illustrating a real-time zoom tool for multiple simultaneous users in accordance with an exemplary embodiment of the invention.

FIG. 2A shows an interface diagram in accordance with an exemplary embodiment of the invention.

FIG. 2B shows an interface diagram in accordance with an exemplary embodiment of the invention.

FIG. 2C shows an interface diagram in accordance with an exemplary embodiment of the invention.

FIG. 2D shows an interface diagram in accordance with an exemplary embodiment of the invention.

FIG. 3A shows an interface diagram in accordance with another exemplary embodiment of the invention.

FIG. 3B shows an interface diagram in accordance with another exemplary embodiment of the invention.

FIG. 4 shows a flow diagram in accordance with an exemplary embodiment of the invention.

FIG. 5A shows a chart in accordance with an exemplary embodiment of the invention.

FIG. 5B shows a chart in accordance with an exemplary embodiment of the invention.

FIG. 6A shows an interface diagram in accordance with an exemplary embodiment of the invention.

FIG. 6B shows an interface diagram in accordance with an exemplary embodiment of the invention.

FIG. 6C shows an interface diagram in accordance with an exemplary embodiment of the invention.

FIG. 6D shows an interface diagram in accordance with an exemplary embodiment of the invention.

FIG. 6E shows an interface diagram in accordance with an exemplary embodiment of the invention.

### DETAILED DESCRIPTION OF THE INVENTION

The present invention is directed to a system and method for providing real-time communication and collaboration over multiple forms of activity, by multiple people online.

From time to time throughout this disclosure the terms “session” and “spatial environment” are used. Unless otherwise stated, session is intended to mean a continuous and specific period of time in which work is carried out by a user within a spatial environment. So session is the actions of a user over a continuous and specific period of time, whereas spatial environment is the location where the action is taking place.

The real-time zoom system comprises one or more client devices each of which includes a client module for a user, and a user Input/Output (I/O) interface. By way of example, the user client device may be a computing device having a processor and memory such as personal computer, a tablet computer, phone, a mobile phone, or a personal digital assistant. The client I/O interface may include a keyboard, mouse, monitor, touch screen or similar interface device suitable for allowing a user to interact with the client device. The client user module is responsible for handling any communication with a server. The real-time zoom system may also include a server device communicatively coupled to each of the client devices by way of a network such as the Internet. The server includes a server module and a data repository for storing data (e.g. spatial environment data, application data and user information). The data repository may also include one or more databases on which specific application data is handled and performed. The server may also be communicatively coupled to one or more remotely located computing devices containing third-party databases on which data for third party applications is handled. By way of example, the server may be a single computing device having a processor and memory or may include multiple computers communicatively coupled in a distributed cloud-based architecture. The server module is responsible for handling communication with each of the client devices, managing storage of user input within applications and for handling data related to visualizing and animating the avatars for all users in a real-time fashion. The server module may access the data repository in response to a data request from one of the client devices.

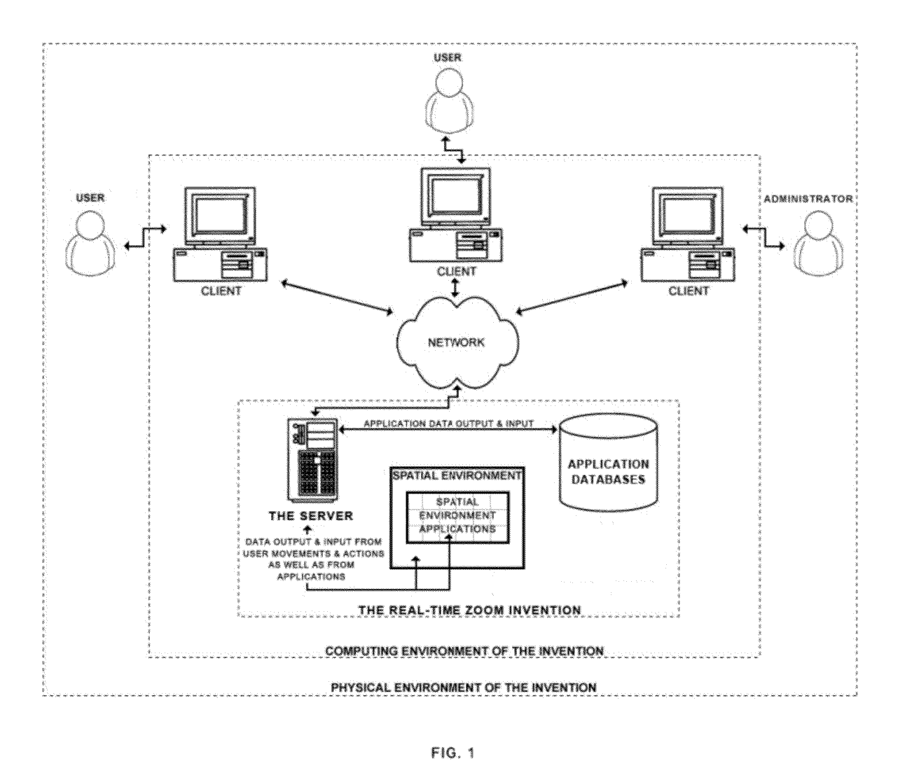

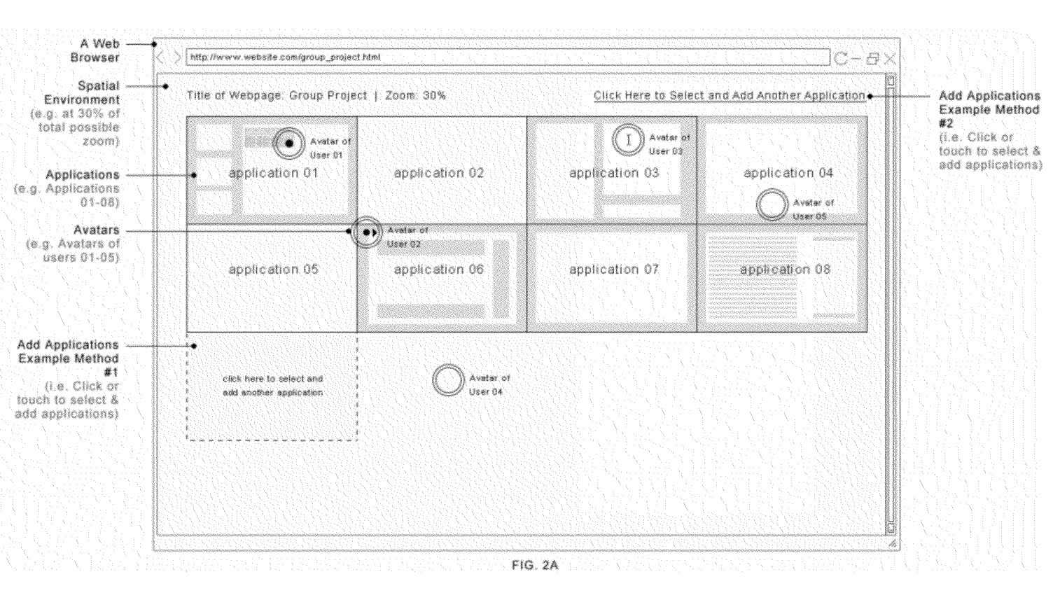

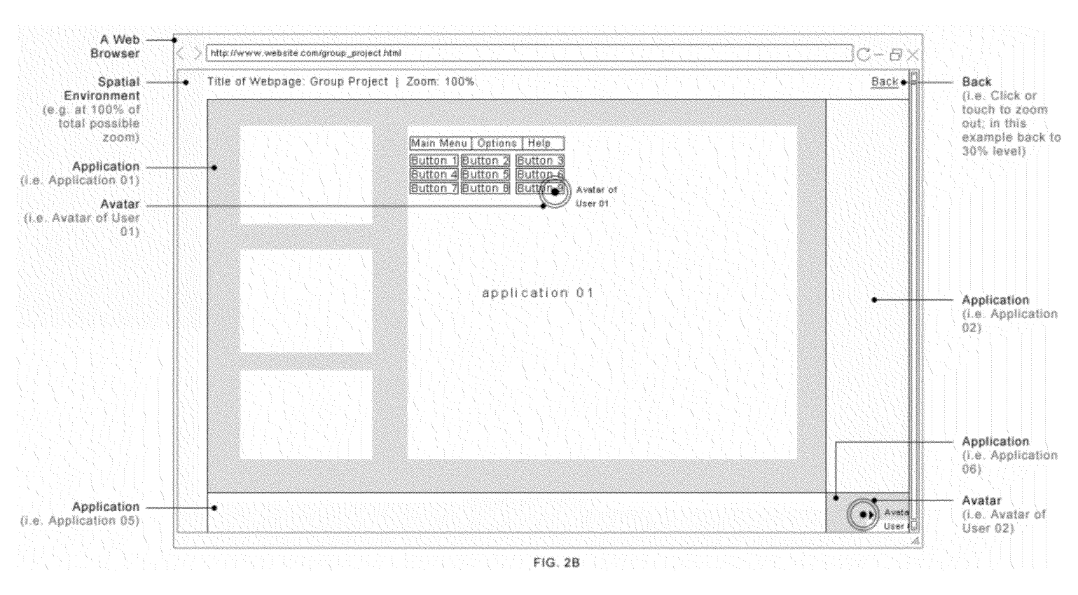

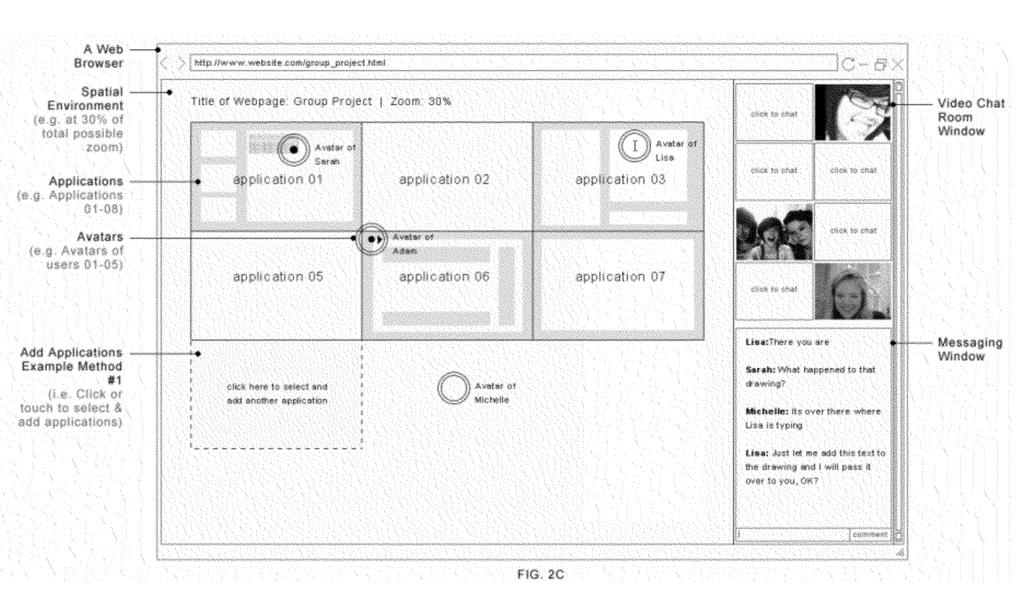

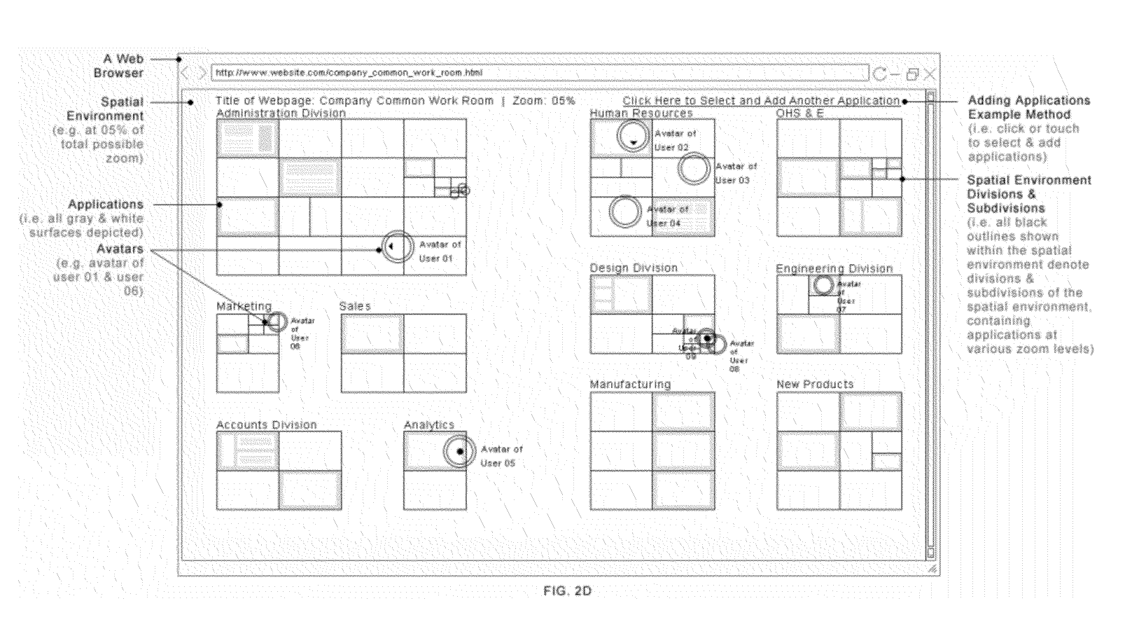

Referring now to FIG. 1, a block diagram is shown illustrating a real-time zoom system in accordance with an exemplary embodiment of the invention. As shown the real-time zoom system may also support end users having different system permission levels. By way of example, the system may support an administrator user for moderating user activity and for screening specific user input. As shown, the server device may be a web server or database server in communication with a data repository for storing spatial environment data and database preferences among other data. The client interface will now be discussed in greater detail with reference to FIG. 2A through 2D.

Referring now to FIG. 2A through FIG. 2D, exemplary interface diagrams are shown for interacting with the real-time zoom system shown in FIG. 1. As shown, the real-time zoom interface may be a web-browser (e.g. Firefox or Google Chrome) based interface. It is noted however that the interface may be implemented as a standalone application suitable for being displayed on, and interfaced via a desktop, a touch sensitive or mobile computing device. The real-time zoom interface allows a user to navigate to one or more unique spatial environments. By way of example, the user may enter a specific web address in the form of a URL, where the web address includes a predetermined unique alpha numeric identifier to be associated uniquely with each spatial environment in the system. The real-time zoom interface also includes a region for displaying such spatial environments. Each spatial environment contains one or more user-provided or pre-loaded applications in which users may engage (e.g. applications 01 to 08) each of which is displayed in the spatial environment display region. Visiting the unique URL of a spatial environment will cause all previously added applications to be loaded and displayed to the user in the spatial environment display region. The spatial environment display region includes pan and zooming capabilities so as not to constrain the quantity or size of the applications that can be added to the size of the screen on which the real-time zoom interface is displayed. The real-time zoom interface also supports selection (e.g. by clicking with a mouse device) of each of the available applications within the Spatial Environment. In response to a selection event the real-time zoom interface will zoom in on the application, bringing it closer to the user so that practical engagement is possible with its interface controls, with other users and data within the application.

As shown in FIG. 2B, by way of example, the application labeled “application 01” has been zoomed in on, allowing the user labeled as “User 01” to be close to and have practical engagement with the application; in this case by clicking on a button. Also notable is the visibility of adjacent applications in this particular implementation shown, where the users engaged in neighbouring applications are also visible (i.e. the visibility of the Avatar of “User 02”). In other implementations, upon selecting and zooming in on an application, neighbouring applications may be masked over so they are not visible to users. The mask cover can be removed automatically by the system upon zooming out.

As shown in FIG. 2C, the real-time zoom interface may also include communication features such as a video chat room and/or messaging window which are unique to each and every Spatial Environment. The users of the Spatial Environment Labeled “Group Project” are identifiable within the Spatial Environment through their avatars, within the video chat room through the video streaming of themselves to the other users, and within the messaging window through their name label.

As shown in FIG. 2D the real-time zoom interface supports the division and subdivision of the area of the Spatial Environment. In so doing the total number of applications that may be made available within any given SPE is increased, as each division and subsequent subdivisions created can contain applications. In addition the divisions allow users to organize their activity within an SPE in a more structured fashion which reflects the types of activities which the group engages in; of which the divisions in FIG. 2D are an example. In the illustrated example given, the SPE is titled “Company Work Room” and is divided into areas reflecting the organizational structure of the company (i.e. those labeled as “Administration Division”, “Human Resources”, “Manufacturing” etc). It is envisioned that the users in this example are company employees, with each working within the division of the SPE which relates to the sector of the company to which they are employed (e.g. User 07 is an engineer and thus is working within the engineering division of the SPE). As is also the case, users are able to move freely across the SPE and so are able to cluster in groups to engage with applications and complete specific tasks across divisions (e.g. as illustrated within the SPE areas labeled “Design Division” and “Administration Division”).

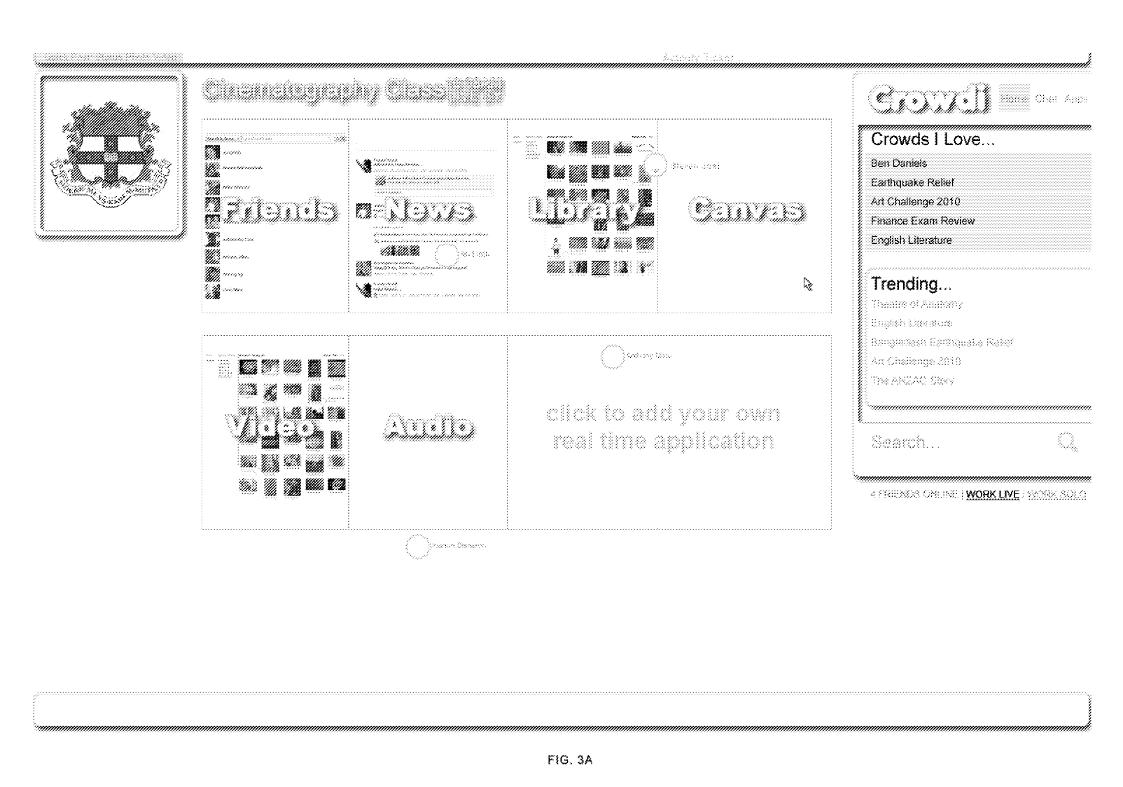

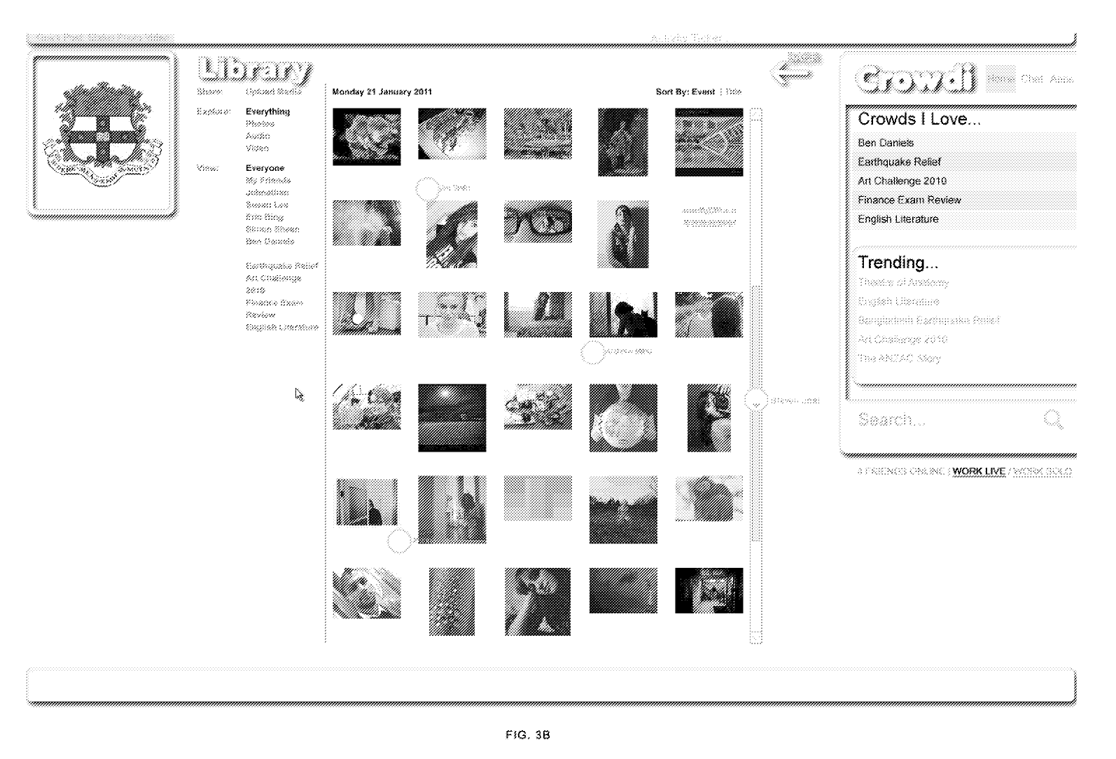

Referring now to FIG. 3A and FIG. 3B, interface diagrams are shown illustrating another exemplary interface for interacting with the real-time zoom system shown in FIG. 1. In particular, FIGS. 3A and 3B illustrate example applications and controls that may be provided by the real-time zoom interface for collaboration within the spatial environment. As shown in FIG. 3A the real-time zoom interface may include menu options (e.g. the “Home” tab where users can select and search for alternative SPE's, a “Chat” tab where users can access a video chat room and messaging services, and an “Apps” tab where users may go to select and add more applications to the SPE). All the available applications are shown at once within the SPE, and all the present users are also observable within the SPE, with all their Avatars in view. Any actions carried out by the users at any time within the SPE are also observable. In the illustrated instance, the avatar of one user, “labeled as “Karen Jones” is shown carrying out an action within the “Library” application. FIG. 3B illustrates the same real-time zoom interface of FIG. 3A, now displaying only the Library application, as that application has been zoomed in on so that it fills the available SPE screen area (In order for a user to zoom out with regards to this exemplary implementation they need to use the “BACK” button as shown in the upper right corner of the SPE). Within the current display we can clearly discern the interaction occurring between the Avatar of user “Karen Jones” and the Library application interface (i.e. scrolling through the photos on display). All other users within the SPE can both observe the Avatar of user Karen Jones, the animation of their avatar in action (action illustrated as an arrow within the avatar), as well as the scrolling of the photos. The same is true for all other actions that may be carried out by any of the users across any of the other applications. As long as a user is zoomed out (as with FIG. 3A) or is not zoomed in on an application where there is no current user activity, all activity by all users to all applications is observable and directly affects all users. In addition, in both FIG. 3A and FIG. 3B the cursor of a user is visible to them only, for all the other present users they are shown their avatar, along with the visualization and animation of any actions they conduct within the SPE applications. Finally, the illustrations show the option to disconnect from other users via the “Work Solo” option which is illustrated next to the “Work Live” setting which is the default and currently selected in the example illustration. Switching to the “Work Solo” setting would cause the Avatars of all users to disappear from view, and any actions (e.g. such as scrolling of an application) would also no longer be visible. Any data input within the library application however (e.g. adding photos) would still be updated and visible to all users.

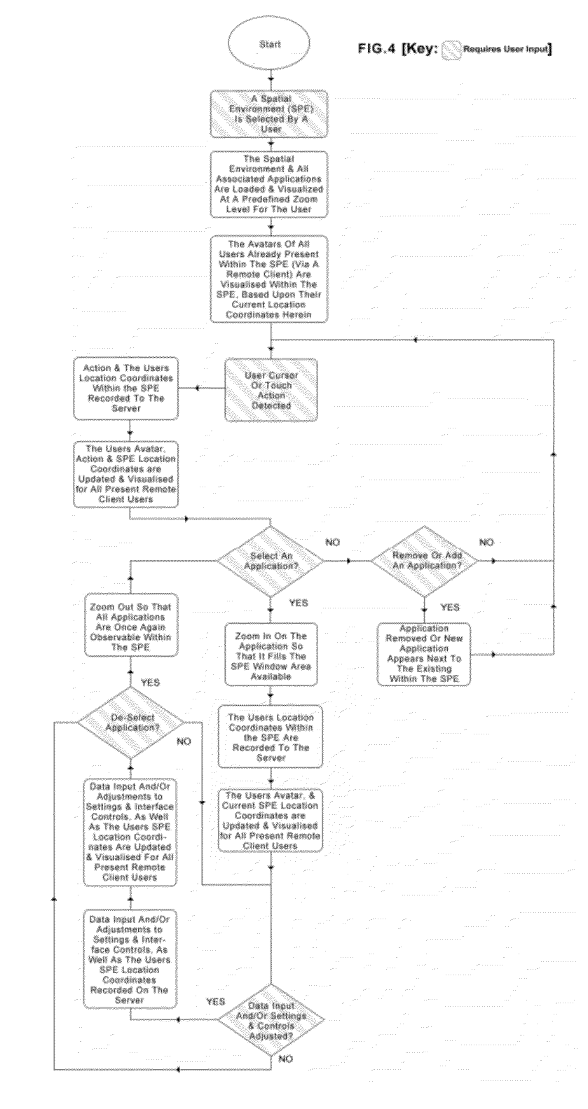

Referring now to FIG. 4, a flow diagram is shown that illustrates a computer-implemented process or method that may be carried out with the exemplary real-time zoom interface system shown in FIG. 1. FIG. 4 illustrates a first series of steps that occur, starting with the selection of a specific Spatial Environment by a user. At this point the selected Spatial Environment and all associated applications are loaded & visualized at a predefined zoom level for the user. The zoom level is calculated based on the level required to adequately view all applications present within the SPE simultaneously. This is followed by having all the avatars of all users already present within the SPE becoming visible, and appearing in accordance with their current location within the SPE. At any point if any user moves within the SPE or makes an action of any kind (e.g. clicking, scrolling, touching etc.) these are recorded to the server and the avatars of the users in question are updated for all users to observe their new location within the SPE and for all to see the updated visualization and animation of their avatar actions.

In the illustrated embodiment of the invention a user has the following options: select an application and the option to add or remove an application. If a user selects an application, the interface will zoom in on the selected application so that it fills the SPE window area available. The user is now able to interact with the selected application at a zoom level where the application fills the available SPE area. If data is input and/or settings and controls are adjusted, all data input and/or adjustments to settings & interface controls made are recorded on the server and updated for all users, as is described and illustrated in the flow diagram. If the user then so chooses they are able to zoom back out to the original zoom level which allows all applications to be again observable and hence they are able to select another application. Finally the option to add or remove an application is provided, where any added applications will appear above, below or to the side of existing applications. It is important to note that the flow diagram illustrates how the invention at all times constantly updates both the avatars of users and any adjustments made to the data input, settings and interface controls of applications, in real-time. Or, the updates are as close to real-time as possible so that for any given user the experience of collaboration is perceived to be in real-time.

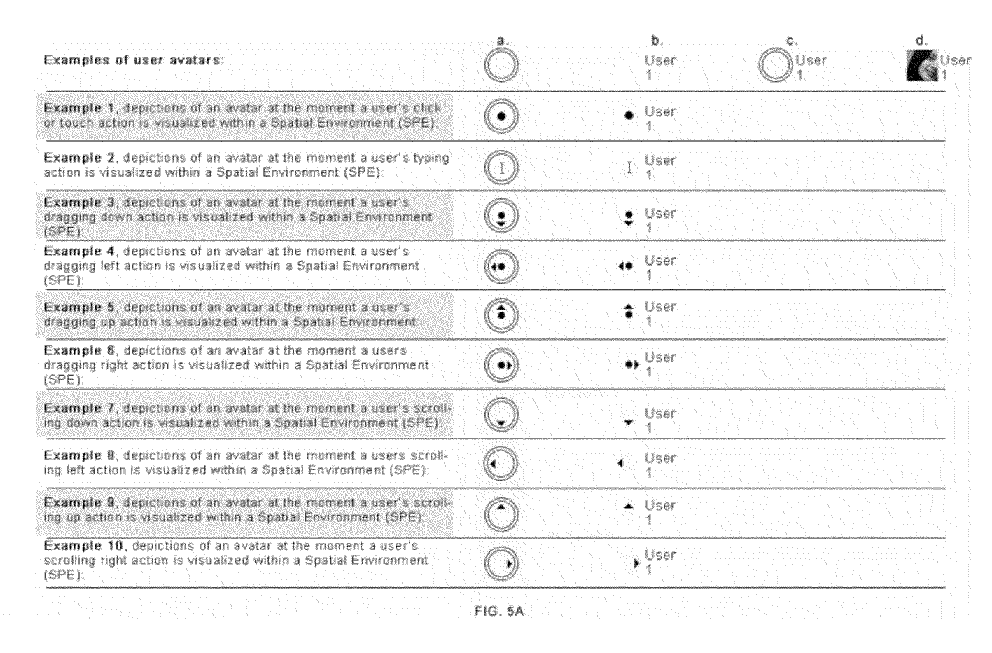

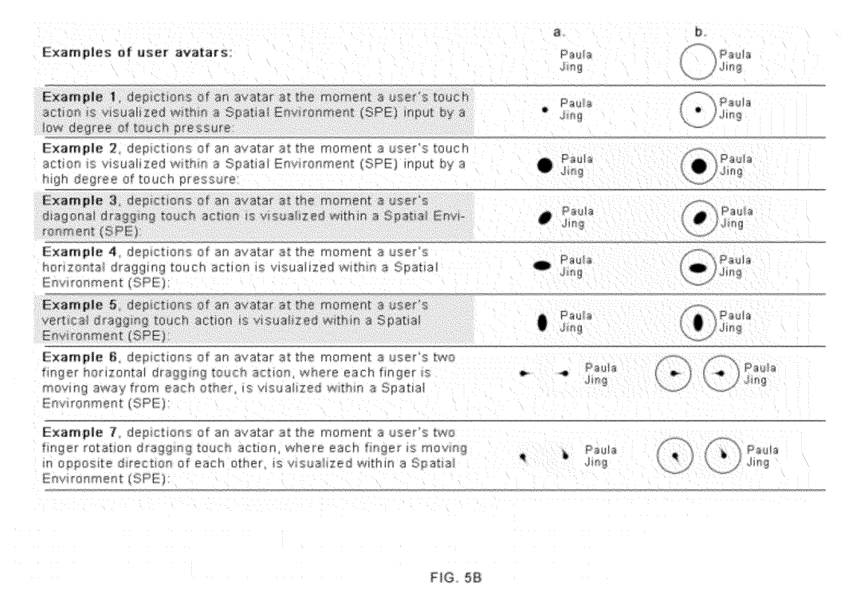

With reference to FIG. 5A and FIG. 5B, examples are shown illustrating exemplary representations of users and their actions of the system shown in FIG. 1. In regards to FIG. 5A, avatars, which are the graphical representations of the users are depicted. The avatars may take the form of, but not limited to, a shape such as example “a.”, a text description of the user or the users name such as example “b.”, or as a photo as depicted by example “d.”. As such, the avatars visualize and animate each and every action of the user (e.g. examples 1-10 of FIG. 5A) and these actions appear visualized within or next to the avatar of a user at the moment the specific action depicted is performed. The visualized and animated actions are intended to be observable by all users present within a Spatial Environment, and therefore each action is of a size and shape that can be clearly identified by users within a SPE.

With reference to FIG. 5B, input actions may originate from users who are interfacing via a touch sensitive display. In such cases the users' touch actions can result in the level of pressure applied to the display being visualized (e.g. examples 1 & 2), a dragging touch action being visualized (e.g. examples 3-5) or those which involve multiple touch actions (e.g. examples 6 & 7). Such actions are visualized and animated next to or within a user's avatar, and are observable by all users within a SPE. All the actions and avatars depicted in FIG. 5A and FIG. 5B are illustrated as way of example, with many more variations of the depicted possible, or entirely new forms of user representation (e.g. three dimensional or animated avatars and actions).

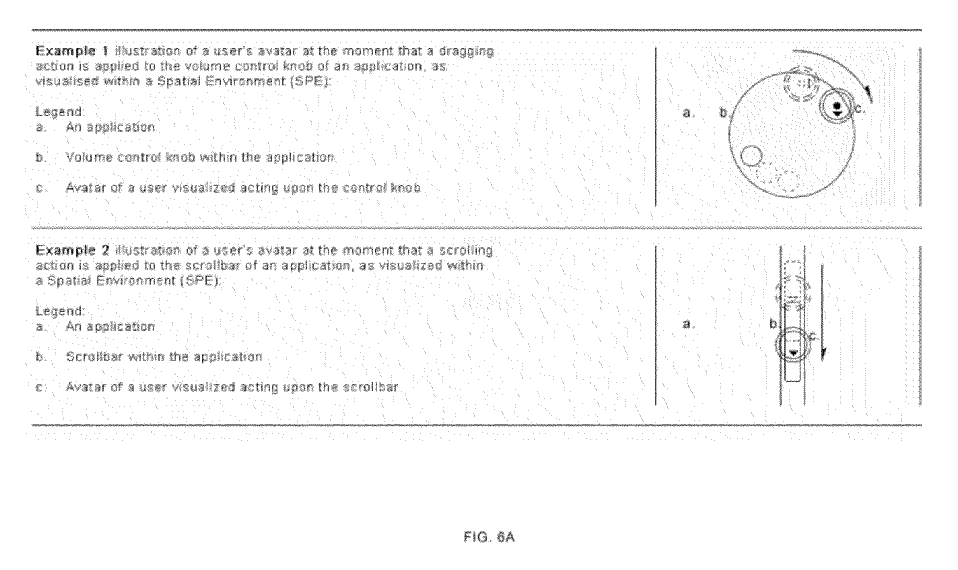

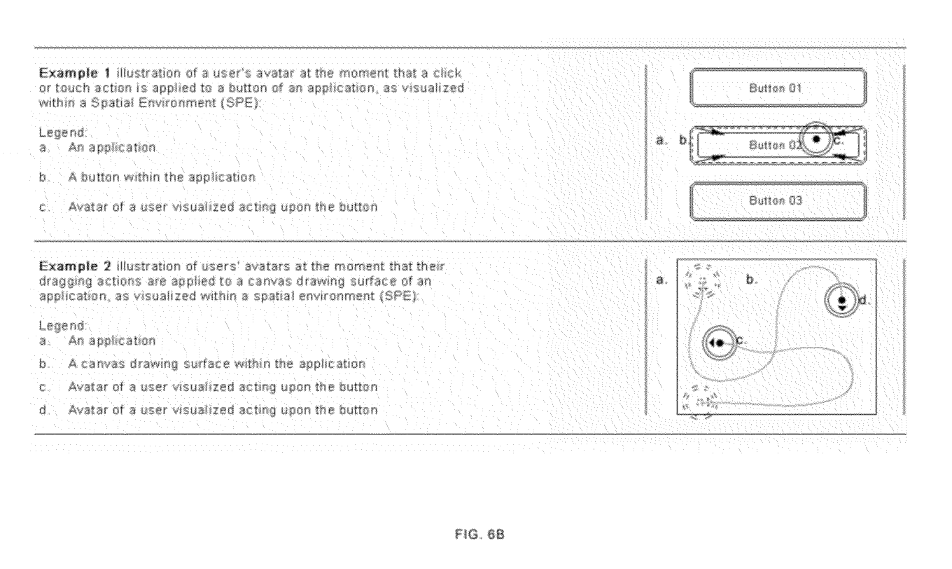

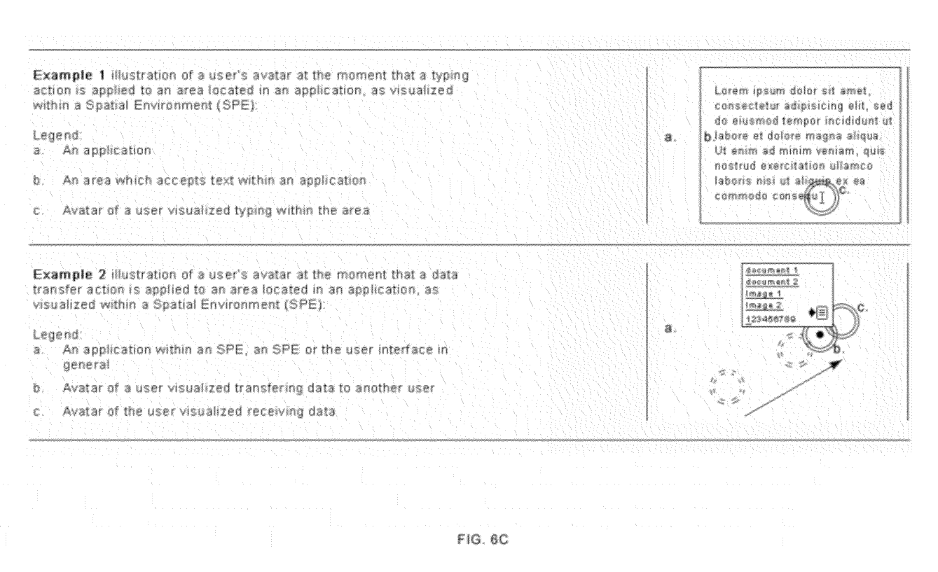

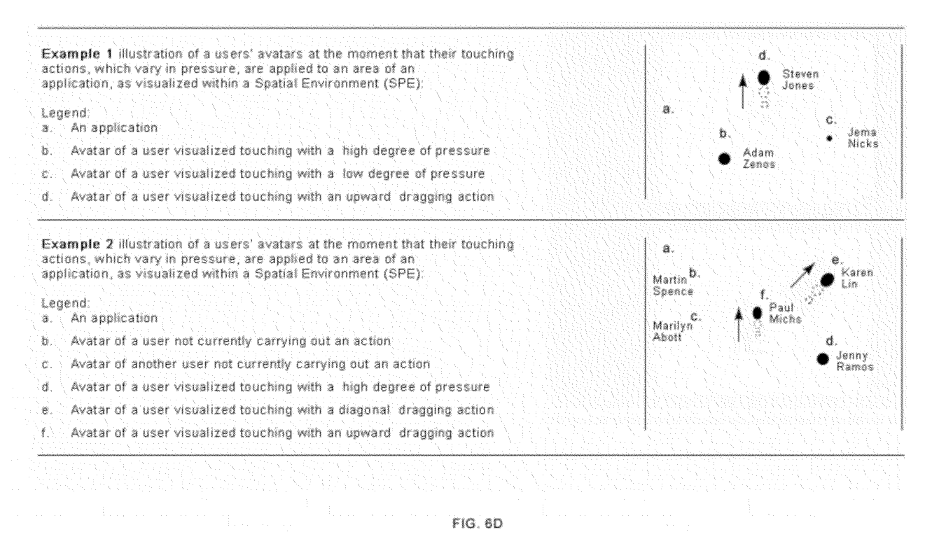

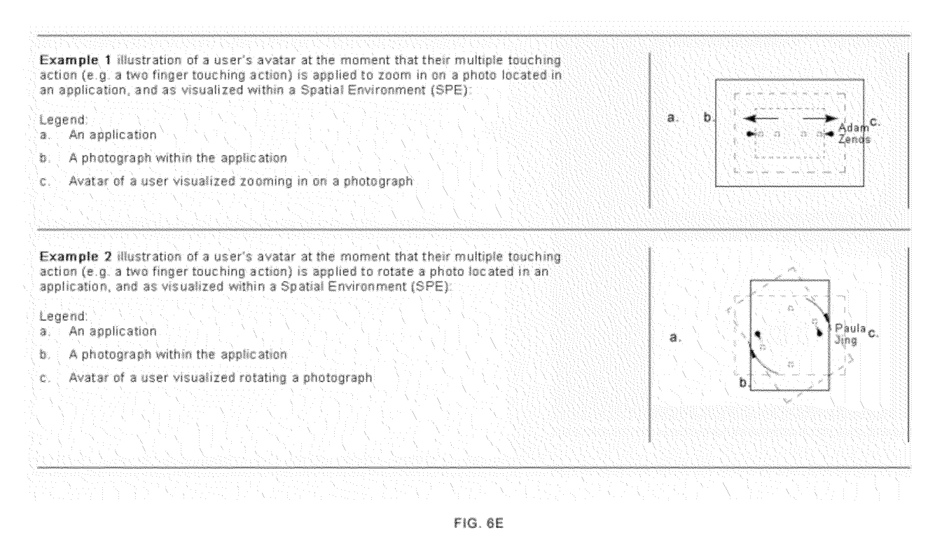

Referring now to FIG. 6A through FIG. 6E, exemplary interface diagrams illustrate user avatars at the moment at which an action is being carried out, and where that action is being applied within an application located within an SPE of the real-time zoom system shown in FIG. 1. All the exemplary avatars and actions are, as illustrated, intended to be observable and affect simultaneously all users present within the specific SPE's and/or applications depicted. All the supplied illustrations are from a third person perspective. FIG. 6A, example 1 shows a volume control knob being turned in a clockwise direction. Both the knob, and the avatar of the user in action, are animated in real-time for all users present to see and be affected (i.e. the volume becomes louder simultaneously for all users). FIG. 6B, example 2 shows a scrollbar of an application being scrolled via a downward dragging action. The scrolling action could be applied to scroll through multiple photos, a long body of text or a document, for all users of an SPE to see and affect. FIG. 6B, example 1 shows a button being pressed by a user. As with all actions within an SPE, the intended result of pressing the button will affect all users and the avatar act of pressing the button will be observed by all present users of the SPE. FIG. 6B example 2 shows a canvas drawing surface being drawn upon by two users simultaneously. The avatars in action and what is being drawn is observable by all users within the SPE depicted. FIG. 6C example 1 shows the avatar of a user who is typing within an application, again from the perspective of all other users who may be present within the SPE. As the user is typing additional users may join in and start typing simultaneously within the body of the text already completed or elsewhere within the application or within other applications located within the SPE. FIG. 6C example 2 shows a user (i.e. labeled as “b.”) transferring data to another user (i.e. labeled as “c.”) by way of moving their avatar so that it overlaps with the other user, at which point a transfer icon appears to indicate that a clicking action at this point would transfer the data to the recipient user. The data which the user is transferring could be an image, text or a file(s) which has originated from a copy command from within any application located in the user's computer. The data can also originate from a folder of files within the real-time zoom system, offered as a remote storage feature and service available to all users of SPE's. As way of example, at the time of transfer, a popup box would appear to allow selection of the specific data required from a list. In this way users can store large quantities of data within the real-time zoom system and select what they would like to transfer to other users which they interface with, as illustrated in the example. FIG. 6D example 1 shows users' avatars at the moment the users' touch actions are visualized for all users within an SPE. User “b.” is represented by their avatar and visualized applying a high degree of pressure with their touch action, whereas user “c.” is shown applying a low degree of pressure with their touch action. User “d.” is shown applying an upward dragging touch action. In this way users who are interfacing with an SPE via a touch sensitive display can be represented via their avatars performing a variety of actions. Once again, these actions are observable by, and affect all users within an SPE. The exemplary actions within FIG. 6D can be applied to the controls of applications and/or control elements of the zoom user interface system. FIG. 6D example 2 shows how users who are interfacing within an SPE via a touch sensitive display will have a persistent presence within the real-time zoom system shown in FIG. 1. Unlike users who interface with the system using a computer mouse (i.e. which provides a continuous stream of coordinates as to the location of the users avatar within a SPE). A user who provides input via touch input only is unlikely to maintain or at all provide a persistent presence as their presence only registers at the moment an action occurs. Therefore the interaction of a touch interfacing user with all other users who register a more persistent presence is intermittent and difficult. To solve the above problem, all touch interfacing users may have a persistent but stationary presence at a predefined location within the application and/or SPE, during those times which they are not providing touch input (e.g. as illustrated with the user's labeled “b.” and “c.” in FIG. 6D). In reference to the illustrated example, if user “e.” were to cease their current dragging touch action, their avatar would then appear below user “c.” in a stationary and persistent presence there. In this way touch interfacing users would have their avatars alternate between an inactive, persistent presence, and an active state of is visualization and animation. Finally, as depicted in FIG. 6E, users who use multiple touching actions can have these actions visualized by their avatars for all other users to see. Example 1 shows an image being zoomed in on for a closer look and the two finger action by the user to achieve this is visualized and animated for all other user to observe. Example 2 also shows a photograph, though in this case a user manipulating a photograph by rotating it (in this case the user action depicted in example 7 of FIG. 5B is the same action illustrated in FIG. 6E, example 2). Once again both the avatar and the photograph in the act of rotation, is observable by all other users present within the SPE.

The various illustrative program modules and steps described in connection with the embodiments disclosed herein may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer implemented method for using a system to input and refine information comprising:
a user or multiple users who's specific computer mouse or touch gesture inputs are visualized and animated for the purpose of having each of the specific inputs made being distinctly discernable by a plurality of observing secondary users who are remotely located;
an incorporated distinct representation of the user, herein described as an ‘avatar’, so that all secondary users can discern their identity;
one or more applications within which the user can make input;
a spatial environment, where all available applications and the user are located.

2. The computer implemented method of claim 1 further comprising a zoom user interface by which means the spatial environment is navigable by the user in the case where more than one application is available.

3. The computer implemented method of claim 2 further comprising the user and the plurality of secondary users who are all able to make input within the applications available, have all their distinct inputs visualized and animated so that they are observable by each other, and are all accompanied by a distinct representation so that their identity may be discerned by each other.

4. The computer implemented method of claim 3 wherein the user and the plurality of secondary users are concurrently using the system in actual or near real-time;

5. The computer implemented method of claim 4 further comprising: assigning a unique URL to the spatial environment.

6. The computer implemented method of claim 5 wherein users are able to restrict who is and is not able to participate in the spatial environment.

7. The computer implemented method of claim 6 wherein users are able to remove existing applications or add additional applications to the spatial environment.

8. The computer implemented method of claim 7 further comprising: automatically logging any changes made within the spatial environment in real time.

9. The computer implemented method of claim 8 wherein the division and also a subsequent subdivision of the spatial environment is permissible in order to accommodate additional applications.

10. The computer implemented method of claim 9 further comprising real-time video chat and/or a text messaging feature within the spatial environment.

11. The computer implemented method of claim 10 further comprising the option for any user to change, as well as customize their avatar representation.

12. The computer implemented method of claim 11 wherein a user can click or touch the avatar of another user in order to communicate specifically with that user via the video chat and/or text messaging feature.

13. The computer implemented method of claim 12 wherein a user can apply a filter or a multitude of filters so that only a specific selection of the users present within the spatial environment are visible.

14. The computer implemented method of claim 13 wherein users are provided with a social status ranking, relative to all other users in the system, so that it is discernable the quality, quantity and popularity of their input in the system to date.

15. The computer implemented method of claim 14 wherein a user is able to transfer data to another user within the spatial environment by clicking or touching the avatar of the other user to initiate the transfer.

16. The computer implemented method of claim 15 wherein multiple spatial environments are available; one for each registered user.

17. The computer implemented method of claim 16 wherein an application programming interface (API) is incorporated into the system, allowing third party applications to be created and be accessible to users within the spatial environment.
